(19) United States
(12) Patent Application Publication
(10) Pub. No.: US 2023/0237505 A1
(43) Pub. Date: Jul. 27, 2023

(54) Automated dispute resolution system

(71) Applicant: Kumiko Kitaoka, Arlington, VA (US)

(72) Inventor: Kumiko Kitaoka, Arlington, VA (US)

(21) Appl. No.: 17/581,954

(22) Filed: Jan. 23, 2022

(51) Int. Cl. G06Q 30/00; G06Q 20/40

(52) U.S. Cl. CPC G06Q 30/0185; G06Q 20/4016; G06Q 50/265

(57) ABSTRACT

Disclosed herein provides an automated dispute resolution system in data communication with a user device comprising: a memory and a processor, the processor configured to receive identification information, scale a risk of misidentification; record a communication in the memory, together with a timestamp; receive input to components of a matter; collect information on the matter; establish a prediction based on a type of dispute resolution and one or more attributes; create an action item; identify a solution; and present the solution to the matter parties. Further disclosed herein provides a method, comprising: receiving identification information, scaling a risk of misidentification; recording a communication in the memory, together with a timestamp; receiving input to components of a matter; collecting information on the matter; establishing a prediction based on a type of dispute resolution and one or more attributes; creating an action item; identifying a solution; and presenting the solution to the matter parties.

### BACKGROUND

### Technical Field

The embodiments herein generally relate to automated dispute resolution platforms, more particularly, assistance of dispute resolution by providing a user with sufficient and timely information and confidence in concluding a dispute.

### Description of the Related Art

With rapid expansion of e-commerce, a traveler can instantaneously find a lowest-priced flight ticket online and pay with a credit card. It is not uncommon for us to transact a deal with an unfamiliar online business without carefully reading fine prints on websites. The volume of online business has multiplied conflicts related to online activities. Better Business Bureau reports that frauds and complaints had dramatically increased during the pandemic as more people had shopped online.

Conventionally, disgruntled consumers have faced substantial difficulty recovering their monies because a business may ignore a customer inquiry even when an item is not delivered as promised. When a business behaved badly, a customer may have to live with a bad experience or pursue a legal action. Even Better Business Bureau does not actively solve a legal issue for many disgruntled customers as they expect.

Certain types of online transactions have inherent dispute resolution mechanisms such as a virtual clearing house. For example, a system of virtual clearinghouse has been created by redeeming digital micro-payments from diverse service providers when parties are participants of such system. Junbo, et al. Virtual Points Clearinghouse, US 2008281692 A1. Computer-implemented dispute resolution systems are previously proposed and disclosed, but these systems are not used to automate the “act of dispute resolution” well enough, or to address difficulties experienced by disputing parties.

### SUMMARY

Disclosed herein, a system comprising a memory and a processor in communication with a user device, the processor configured to: receive identification information from a communicating user; scale a risk of misidentification of the communicating user; record a communication from the communicating user, together with a timestamp; receive input to components of a matter from the communicating user when the communication desires dispute resolution, wherein the components of the matter comprise: matter parties; alleged facts; and a desire of the communicating user; collect information on the matter; evaluate one or more attributes of the matter; scale dispute resolution progress of the matter until the matter is terminated; establish a prediction based on a type of dispute resolution and analysis of the one or more attributes; create an action item for one or more of the matter parties according to the information on the matter, dispute resolution progress of the matter, considering the prediction together with the one or more attributes; identify a solution based on the type of dispute resolution, dispute resolution progress of the matter, and desires of the matter parties; and present the solution to the matter parties.

Further disclosed herein, a method, comprising: receiving identification information from a communicating user, scaling a risk of misidentification of the communicating user, recording a communication from the communicating user in a memory, together with a timestamp, receiving the communicating user's input to components of a matter when the communication desires dispute resolution, wherein the components of the matter comprise: matter parties; alleged facts; and a desire of the communicating user; collecting information on the matter; evaluating one or more attributes of the matter; scaling dispute resolution progress of the matter until the matter is terminated; establishing a prediction based on a type of dispute resolution and analysis of the one or more attributes; creating an action item for one or more of the matter parties based on the information on the matter, dispute resolution progress of the matter, considering the prediction together with the one or more attributes; identifying a solution based on the information on the matter, the type of dispute resolution, dispute resolution progress of the matter, and desires of the matter parties; and presenting the solution to the matter parties.

### BRIEF DESCRIPTION OF THE DRAWINGS

The embodiments herein will be better understood from the following detailed description with reference to the drawings, in which:

FIG. 1 is a flow diagram illustrating an environment in which an automated dispute resolution system with various modules may operate;

FIG. 2 is a schematic diagram showing an environment with an automated dispute resolution system in accordance with the embodiments herein;

FIG. 3 illustrates an automated dispute resolution system with separate modules in accordance with certain embodiments herein;

FIG. 4 is a schematic diagram illustrating a module of an automated dispute resolution system in accordance with the embodiments herein;

FIG. 5 illustrates a schematic diagram of a module in accordance with the embodiments herein;

FIG. 6 illustrates a schematic diagram of a module in accordance with the embodiments herein;

FIG. 7 illustrates a schematic diagram of a module in accordance with the embodiments herein;

FIG. 8 illustrates a schematic diagram of a module in accordance with the embodiments herein;

FIG. 9A-9E illustrate a flow diagram of an exemplary automated dispute resolution system in accordance with the embodiments herein;

FIG. 10A illustrates a flow diagram showing operations at an exemplary record module in accordance with the embodiments herein;

FIG. 10B, 10C illustrate a flow diagram of an exemplary automated dispute resolution system with a record module, in accordance with the embodiments herein;

FIG. 11A illustrates a flow diagram of an exemplary case management module, an exemplary verifier module, and external architectures in accordance with the embodiments herein;

FIG. 11B illustrates a flow diagram of an exemplary record module, an exemplary verifier module, and external architectures in accordance with the embodiments herein;

FIG. 11C illustrates a flow diagram of an exemplary case management module and external architectures in accordance with the embodiments herein;

FIG. 11D illustrates a flow diagram of an exemplary record module and external architectures in accordance with the embodiments herein;

FIG. 12 is a flowchart of a method of verifying a communicating user, recording a received communication, processing of the received communication at a case management module, analyzing a matter, predicting a dispute resolution, navigating matter parties, and settling a matter, in accordance with the embodiments herein;

FIG. 13 is a flowchart of a method of verifying a communicating user, in accordance with the embodiments herein;

FIG. 14 is a flowchart of a method of recording a received communication, in accordance with the embodiments herein;

FIG. 15 is a flowchart of a method of processing of a received communication at a case management module, in accordance with the embodiments herein;

FIG. 16 is a flowchart of a method of analyzing a matter, in accordance with the embodiments herein;

FIG. 17 is a flowchart of a method of predicting a dispute resolution, in accordance with the embodiments herein;

FIG. 18 is a flowchart of a method of navigating matter parties, in accordance with the embodiments herein;

FIG. 19 is a flowchart of a method of settling a matter, in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It should be noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition the order of the operations may be re-arranged. Each block of the flowchart can be implemented, for example, by computer readable program instructions, as well as combinations of blocks can be implemented. More than one methods may be shown in one flowchart. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

In this disclosure, terms “register,” “store,” “save,” and “record” are interchangeably used to mean any storing, retention, or registration of a user's input, data, mathematical formulae, products of computation, and the like, using a suitable medium for such purpose.

Terms “provide,” “offer,” “deliver,” “furnish,” “give,” “afford,” and “hand to” are interchangeably used to mean any of the following: delivery of information, data, contents, signals, graphics, numbers, or electronic outputs; performance of a function, a process, a method, or a system; or offering of an option, selection, or an object.

Terms “show,” “display,” and “present” are interchangeably used to mean presentation of information, data, contents, signals, graphics, numbers, electronic outputs, and the like.

Terms “transmit,” “provide,” “relay,” “convey,” “deliver,” “offer,” “emit,” “send” are interchangeably used to mean exporting information, data, contents, signals, graphics, numbers, electronic outputs, and the like, or a content.

Terms “attribute,” “nature,” “characteristic,” and “feature” are interchangeably used to mean any characteristic, feature, inclination, habit, custom, philosophy, proposition, feeling, thinking, tendency, behavior, and the like of a person (natural and legal), a group, a representative, a conflict, a dispute, a claim, a situation, a history, a setting, an environment, etc.

Terms “matter” and “dispute” are interchangeably used. A dispute may start when a person accidentally bumps into an opponent and injures the opponent. A dispute may terminate through successful dispute resolution or merely through passing of time (e.g., a claimant passes away, or a claimant forgets about a matter). Term “successful” means termination or conclusion of a matter (a dispute) by a final disposition at the automated dispute resolution system through dispute resolution that disputing parties mutually selected or agreed to. This includes a voluntary and knowing dismissal (cessation, discontinuation) of a matter by a compromise among all disputing parties.

The embodiments herein provide a method of automated disputed resolution, comprising: verifying identity of a communicating user especially when the communicating user provides input to a system, electronically via a fax or an email, by phone, by mail, or orally in person, scaling a risk of misidentification of the communicating user, recording a communication in a memory with a timestamp, after handling the communication as an inquiry, a request, or an input, receiving input to capture components of a matter, collecting information on the matter, scaling dispute resolution progress of the matter, establishing a prediction to assess a probability of realizing successful dispute resolution, based on a type of dispute resolution and one or more attributes of the matter, creating an action item for one or more of matter parties to navigate the matter parties, and settling the matter.

The embodiments herein provide an automated dispute resolution system in data communication with a user device comprising: a memory and a processor, the processor configured to receive identification information from a communicating user, scale a risk of misidentification of the communicating user; record a communication from the communicating user in the memory, together with a timestamp; receive the communicating user's input to components of a matter when the communication desires initiation of dispute resolution, wherein the components of the matter comprise: matter parties; alleged facts; and a desire of the communicating user; collect information on the matter; evaluate one or more dispute attributes; scale a dispute resolution progress until the matter is terminated; establish a prediction based on a type of dispute resolution and the one or more attributes; create an action item for one or more of the matter parties according to the dispute resolution progress, considering the prediction together with the one or more attributes; identify a solution based on the type of dispute resolution, the information on the matter, the dispute resolution progress, and desires of the matter parties; and present the solution to the matter parties.

The embodiments described herein facilitate voluntary out-of-court dispute resolution.

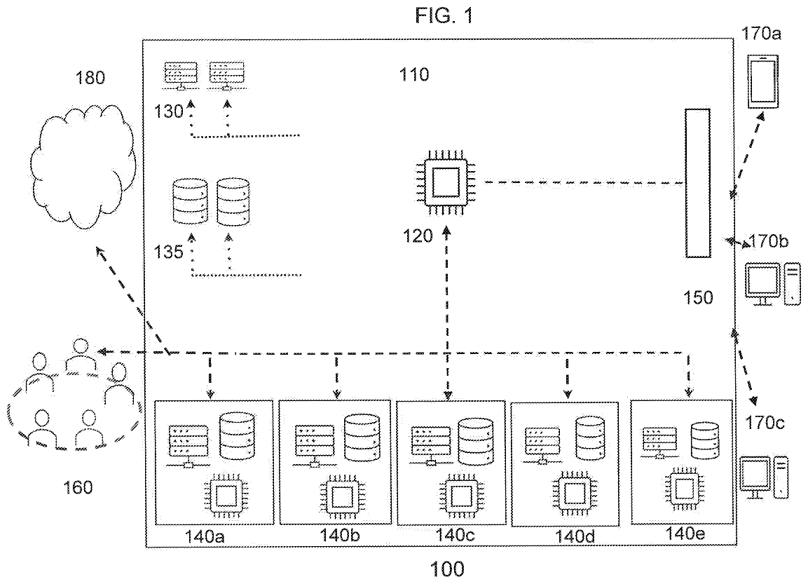

FIG. 1 illustrates a flow diagram of an environment 100 wherein an automated dispute resolution system 110 might be used. The automated dispute resolution system 110 may include a processor 120, one or more servers, 130, one or more memories 135, one or more modules 140a, 140b, 140c, 140d, 140e, an I/O interface 150. The environment 100 may include one or more user devices 170a, 170b, 170c, a remote forum (virtual or physical) for a dispute resolution 160, and telecommunication networks 180.

As shown in FIG. 1, a user device 170a (e.g., a mobile device) associated with a first user sends and receives messages to the system 110. The system 110 may interact with a user device 170b (e.g., a computer) associated with a second user in parallel. The system 110 may further interact with a user device 170c (e.g., a computer) associated with a third user.

The first user, 170a, the second user, 170b, and the third user, 170c, may be independent from and be strangers to each other. In some embodiments, the first user and the third user may be in an active conflict against each other. Thus, communications between the system 110 and each user should be a secure communication.

The first user, 170a, the second user, 170b, and the third user, 170c, may communicate with the system 110 via I/O interface 150.

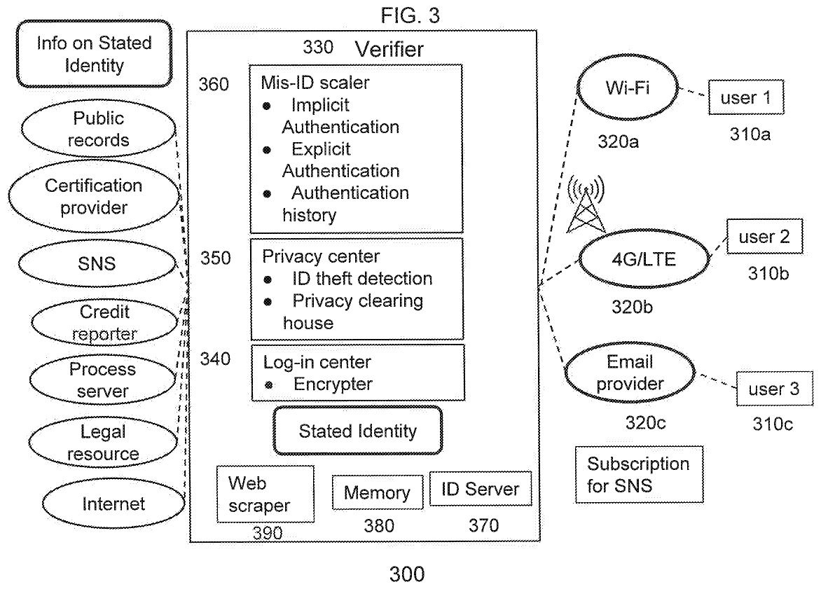

I/O interface 150 may be a mailbox, a fax machine, an email system, a web site's Application Programming Interface (API), a phone, or a counter in a building as depicted in FIG. 3.

After I/O interface 150 receives communication from a user device 170a, the communication may be passed on to a processor 120 in a digital form and processed through the processor 120.

The processor 120 may obtain network connection information about the user device 170a from data received from the user device 170a. Additionally, the processor may retrieve information from a memory 135, a server, 130, or from websites through communication networks 180.

The system 110 may include one or more modules 140a, 140b, 140c, 140d.

In some embodiment, a verifier, a record, an analyzer, a navigator, a settler, or any combination of these can constitute a part of the system 110.

In preferred embodiments, the system 110 may suggest to disputing parties an option of having a forum 160 to virtually talk with each other, with or without a neutral. The forum 160 is depicted as an external element to the system 110, as one example. However, the forum 160 may be included in the system 110, for example, as a part of the settler.

In certain embodiments, each module 140 may include a processor, a server, and a memory, separately from other modules.

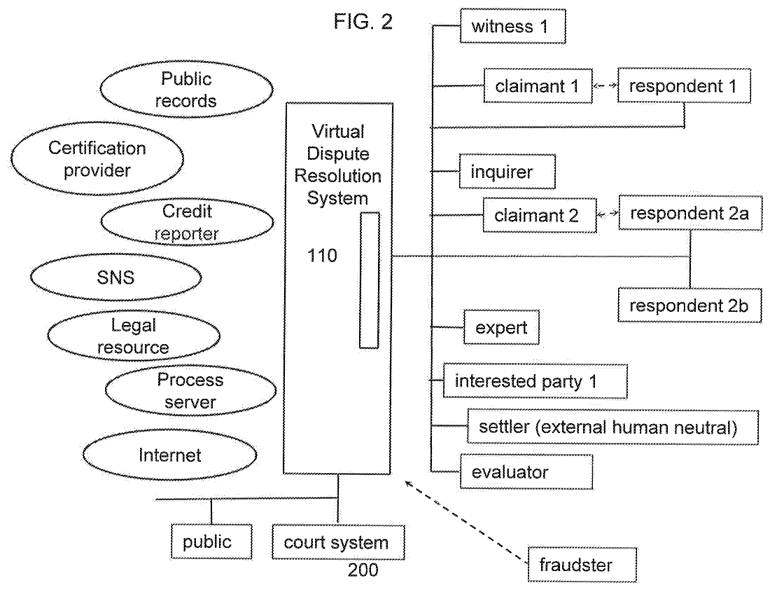

FIG. 2 is a schematic diagram illustrating an environment 200 in which the automated dispute resolution system may be used. As depicted in FIG. 2, the system 110 may interact with a wide variety of users: a witness, a claimant, an inquirer, an interested party, a respondent, a settler (external human neutral), an expert, an evaluator, a fraudster, a court system, and public.

In certain embodiments, there may be multiple parties, such as two or more respondents. There may be two or more claimants. Multi-party situations present a challenge to alternative dispute resolutions. Because out-of-court dispute resolutions usually prioritize efficiency and free will of the parties over the formality and uniformity. In this regard, the instant disclosure may have an advantage over existing out-of-court systems because it may periodically re-evaluate progress made in the matter to realize a successful termination of the matter and offer options to the matter parties.

The system 110 may utilize online resources as well as third-party vendors. For example, the system may interact with a court system, and receive information about a case relevant to the matter parties if the information is legally obtainable. In certain situations, a court may fulfill a supplementary role as set forth by arbitration law. Therefore, the system 110 may request assistance from a court or receive directions from a court.

While the system 110 is operable 24 hours and accessible from any location, a communicating user is preferably linked to a real natural person or a real legal person because the communication's authenticity and credibility can become an issue. A fraudster may impersonate a real natural person and may demand a payment from an unsuspecting victim.

As one way to prevent identity theft and detect frauds, the system 110 may collect information from public records, such as a land record, confirm a user's credentials through a certification provider, confirm a user's online identity through social networking service (SNS), check a user's credit score and identity through a credit reporter, check a user's physical location through a process server, a user's credibility through legal resource, obtain information about a user's activity through internet.

While many out-of-court dispute resolution matters proceed by a dialogue among the matter parties and a neutral if there is any, there are matters in which a witness, an expert, an evaluator, and the like participate in dispute resolution. In such situations, it is very important to verify whether a communication is truly made by the witness, etc.

FIG. 3 illustrates an environment 300 in which the automated dispute resolution system may be implemented.

In one example, the system 110 may verify identity of a communicating user 1, 310a, through a verifier 330. The communicating user 1, 310a may contact the system 110 via Wi-Fi 320a. The communicating user 1, 310a may provide identification information himself/herself (his or her name), or the telecommunication carrier may provide an IP address.

A Mis-ID (identification) scaler 360 may be included in the verifier 330 to locate implicit authentication, explicit authentication, and authentication history of the communicating user 1, 310a. The verifier 330 may collect information on the stated identity from various sources, including internet. Therefore, information obtained from the communicating user 1, 310a, as well as information from external sources may be used to assess the risk of misidentification of communicating users.

In some implementations, the verifier 330 may obtain identification information of the communicating user 2, 310b, through a mobile phone network company (telecommunication service provider), 320b. A unique identifier of the communicating user's mobile phone may be received by the verifier 330 and stored at a memory 380.

In preferred embodiments, the verifier 330 may obtain permission of data collection from a communicating user 3, 310c or access to a subscribed SNS account.

In certain embodiments, the verifier 330 may store the stated identity and detected implicit authentication as well as information scraped from SNS in an ID server 370.

A web scraper 390 may collect information about people with same names from public records to check an error of identification of the communicating user 310.

The verifier 330 may have a privacy center 350 in some embodiments. The privacy center 350 may work as a clearing house for processing or detaining personal information of communicating users 310.

The privacy center 350 may also detect identity fraud, misuse of credentials obtained in a data breach by searching incidents of data breaches online via a web scraper 390.

The verifier may also set up credentials of user log-ins. The log-in center 340 may also encrypt communications received from a communicating user whose identity has been verified.

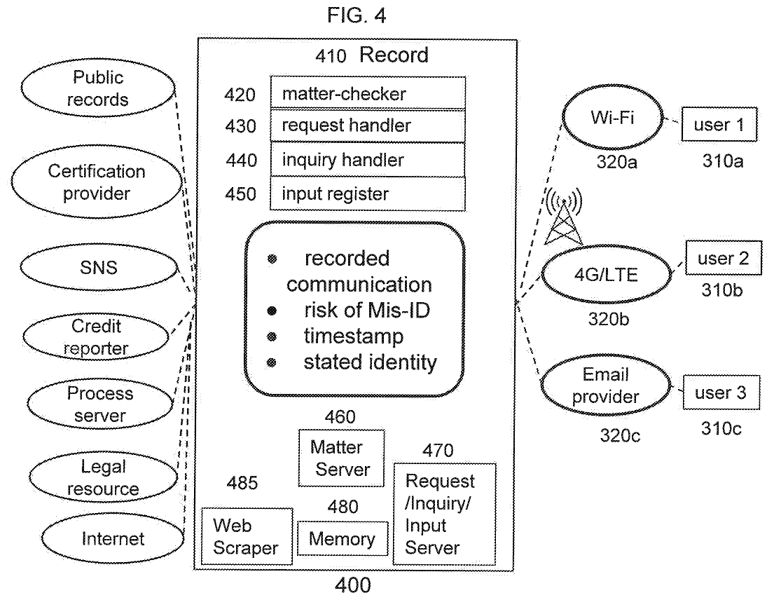

FIG. 4 illustrates an exemplary environment 400 in which the disclosed automated dispute resolution system 110 described herein may be utilized. As depicted in FIG. 4, the system 110 may be implemented with a record module 410, for example, in a cloud computing environment 400.

The record 410 may include one or more submodules such as a matter checker 420, a request handler 430, an inquiry handler 440, an input register 450.

The matter checker 420 may receive a stated identity of a communicating user (310) from the verifier 330 and a risk of misidentification from a Mis-ID scaler 360.

The matter checker 420 may search for a matter involving someone with the stated identity that has been recorded in the matter server 460.

In certain embodiments, the matter checker 420 may filter matters by the stated identity and retrieve previous matters of the communicating user (310a) at a matter server 460. This may prevent re-initiate dispute resolution for one dispute once more that has been already settled.

The request handler 430 may identify a request in a communication from a communicating user (310). For instance, a communicating user may want to initiate arbitration, or may wish to receive an impartial assessment of a real property that she bought from her opponent.

The request handler 430 detects a communicating user's intent to receive assistance from the system 110 and retrieve data from request/inquiry/input server 470. The request/inquiry/input server 470 may provide terms indicating requests, to the request handler 430. The request handler 430 may solicit further information about the communicating user's request by producing responses.

In certain embodiments, if initiation of dispute resolution is requested with sufficient information, the request handler 430 may transmit components of a new matter to an open blockchain in either an anonymized or unanonymized form. If there is information that disturbs privacy of the matter parties but is supposed to be sent to the open blockchain, the matter parties should make a request for protective orders to the record 410. The request handler 430 may retrieve information from the request/inquiry/input server and decide whether the need for secrecy clearly outweighs need for transparency and fairness.

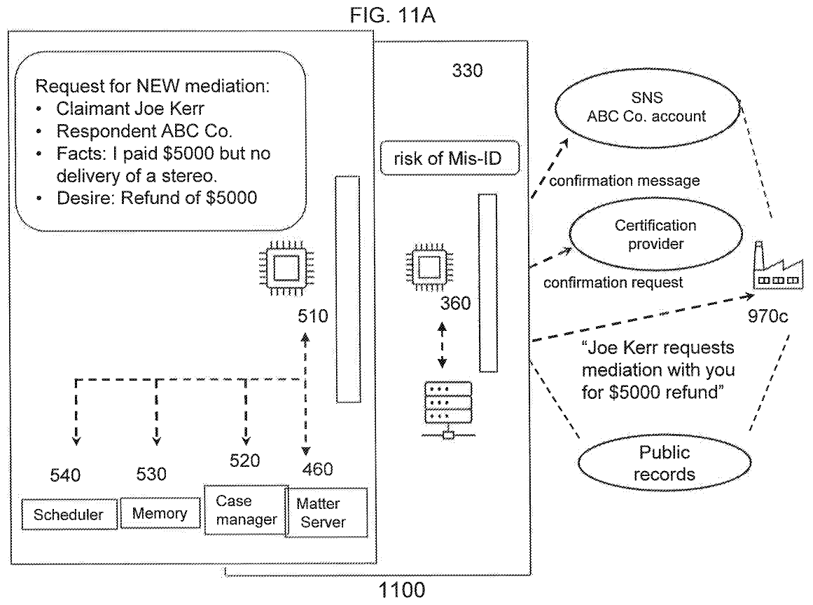

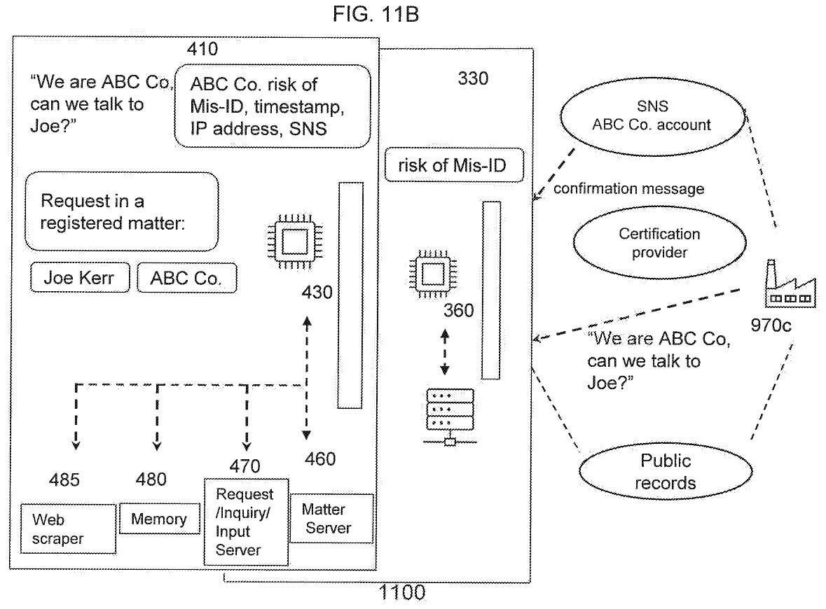

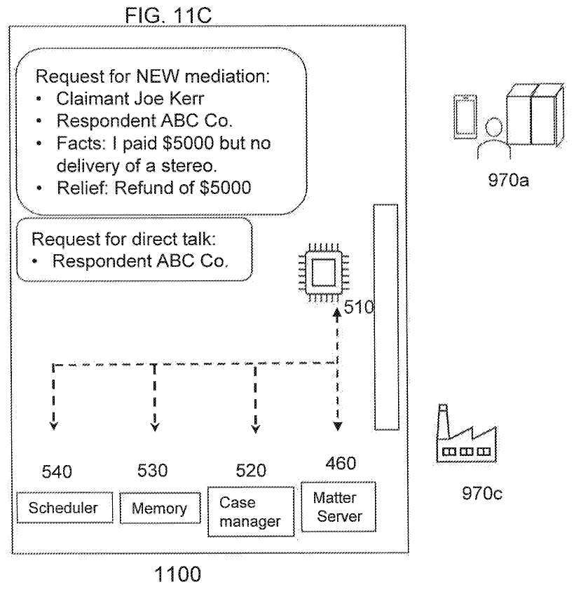

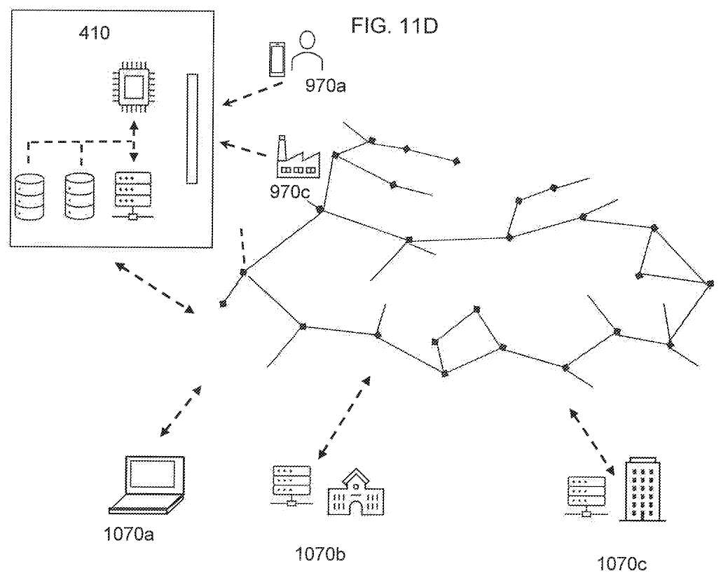

FIG. 11D shows an exemplary environment in which a new matter between a claimant Joe Kerr 970a and a respondent ABC Co. 970c is being placed onto a blockchain through the record 410. The blockchain is also accessible to other users 1070a, 1070b, 1070c. Each user of the blockchain may enter a new matter so that summaries of matters may be available to public.

Also, the record 410 may store original communications in the memory 480 and encrypt communications to protect confidential information of a communicating user (310a, 310b, 310c) before recording communications at the matter server 460. Encryption keys may be saved at the memory 480. Personal sensitive information and confidential information about communicating users will not be divulged.

Automated initiation processes at the record 410 may include: receiving inputs (e.g., what to ask) from the case management 510, and providing responses to a communicating user (310).

The inquiry handler 440 may detect a question seeking an answer in a communication from a communicating user (310). For instance, a communicating user (310) may want to know whether the system 110 has received any input from an interested party or may wish to know whether the system may assist her with assessment of a real property's value. Inquiries may extend not only to a status of a matter, but also to an action item, recorded communications, and the system.

The inquiry handler 440 may request inputs from a communicating user (310) to ascertain that what kind of information is sought. Data stored at request/inquiry/input server 470 may include representative questions and typical answers to them.

The request/inquiry/input server 470 may provide algorithmic steps to the inquiry handler 440 for evaluation of communications.

The input register 450 may detect an input of information in a communication from a communicating user (310). For instance, a communicating user (310) may want to inform the system 110 that the communicating user (310) is amending her argument, or may wish to notify the record that there is a related matter handled by another dispute resolution system.

The input register 450 may request further inputs from a communicating user (310) to determine to what matter the communication is related. Data stored at the matter server 460 may include statuses of pending matters. The input register 450 may update a matter's status based on the communication. The matter's status may include submitted evidence and submitted arguments.

In preferred embodiments, a request, an inquiry, or an input may be temporarily stored at a memory 480 until sufficient information is obtained. The record 410 may request further information to properly understand the communication.

The record 410 may ultimately record the communication into the matter server 460 with a timestamp, a stated identity, and a risk of misidentification.

In embodiments of the instant disclosure, a proper response to a user's inquiry, request, or input of information may be produced by the record 410. The system 110 saves a user's discomfort, hesitancy, and potentially, unexpected loss from legal errors (such as a waiver of a right).

A user may receive needed information from the record 410 by the inquiry handler 440 and may be incentivized to try a dispute resolution system. A prompt response to a smallest inquiry is a substantial advantage, compared with a long hold, waiting for a response from a court clerk or a customer service.

In one example, when a communicating user 310 makes a request for processing a dispute, the request is recorded 410, and shared with the case management module 510.

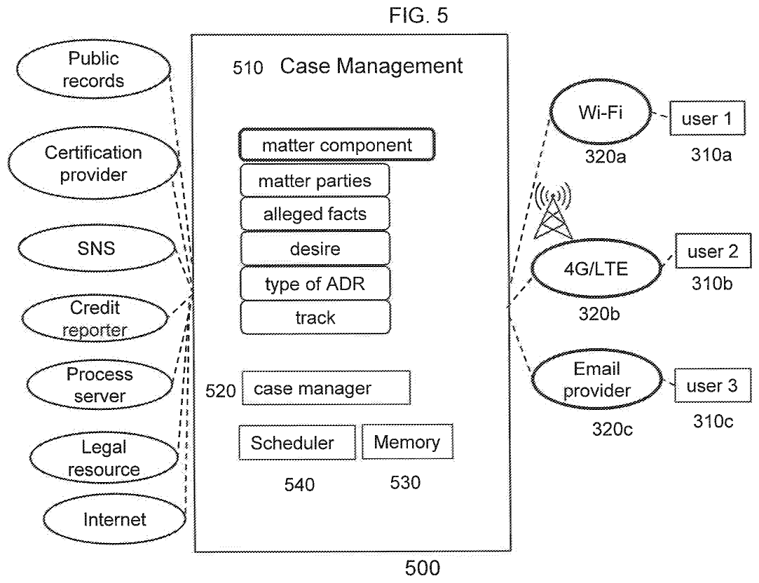

As depicted in FIG. 5, the system 110 may include the case management module 510.

The case management 510 may include one or more submodules such as a case manager 520 and a scheduler 540.

In certain embodiments, the case management module may prompt input from a communicating user 1 310a to components of the matter when the communicating user 1 310a wishes to initiate dispute resolution. The components may include matter parties, alleged facts, and a desire of the communicating user. Because the persons (natural persons and legal persons) who participate in a dispute resolution are affected by a final binding disposition in a matter, the parties involved in the matter (especially, a matter that will be resolved by a neutral's binding decision) are important components of the matter.

Likewise, a matter may be identified by alleged facts and a desire of the parties in the matter.

A type of dispute resolution may be included as one of matter components. The most commonly used dispute resolution may be mediation, but the type of dispute resolution may be arbitration, neutral assessment, mediation-arbitration, or multi-layered dispute resolution (successive use of multiple types of dispute resolution).

For example, when disputing parties agree to arbitrate their dispute, the disputing parties designate arbitration as the type of dispute resolution. The case management 510 may collect information on the matter and determine whether there is an arbitration agreement between the matter parties. The case management 510 may also determine whether the arbitration agreement is valid and not waived.

The case management 510 may assign a case number when a fee for the matter is paid.

The case management 510 may assign a case manager 520 to the matter. The case manager 520 may be a program (virtual) in certain embodiments. The case management 510 may assign a human case manager if it is proper for the matter.

The case management 510 may select a track to the matter among a plurality of tracks. A track works as a recommended timeframe for submission of evidence or arguments and guides the case manager 520 and the matter parties to timely completion of their action items. The plurality of tracks may include: emergent; urgent; simple; regular; and detailed.

The case management 510 may set a deadline of an action item in the matter, considering dispute resolution progress of the matter, including submitted evidence and arguments. A scheduler 540 and a memory 530 may exchange information about any uncompleted action item and its deadline and allow the case manager 520 to solicit performance of the uncompleted action item.

The case management 510 may determine whether an action item for the case manager 520 has been completed. The case management 510 may also determine whether an action item for one or more of the matter parties are performed.

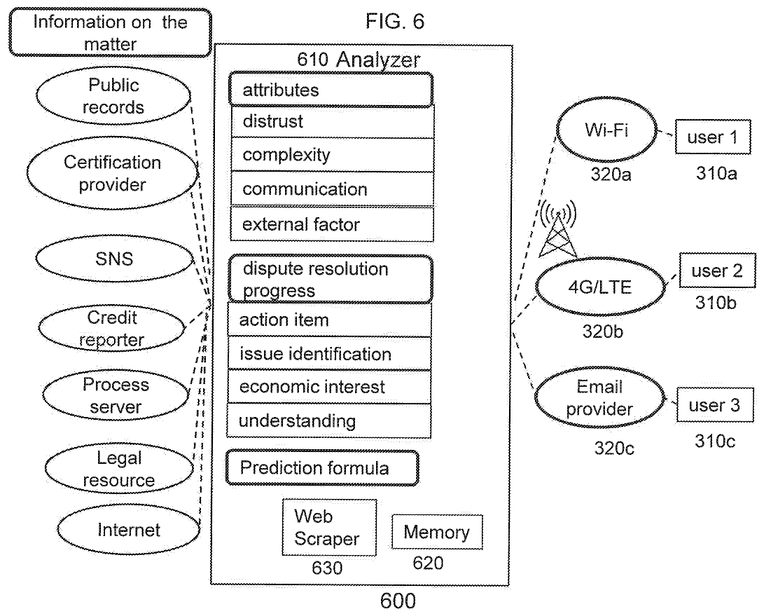

FIG. 6 illustrates an environment 600 in which the automated dispute resolution system may be implemented to evaluate dispute resolution progress and predict an outcome of a matter by the analyzer 610.

As depicted in FIG. 6, the analyzer 610 may collect information on the matter from public records, from internet by a web scraper 630, from the components of the matter that are stored at the memory 530 of the case management 510, from the matter server 460, and the request/inquiry/input server 470.

“Progress” of dispute resolution may be measured by the following: degrees of action item completion as determined by the case management 510; issue identification by submission of argument and evidence; the matter parties' economic interest in dispute resolution; and mutual understanding. The analyzer 610 may scale dispute resolution progress of the matter by examining the information on the matter.

In addition to keeping track of dispute resolution progress, the system 110 can further assist the matter parties by objective assessment of prediction of the matter. The analyzer 610 predicts how likely it is for the matter parties to successfully terminate the matter, either by obtaining a final and binding decision handed down by a neutral, or by reaching an agreement to compromise or agreeing to a settlement between the matter parties (including a settlement through mediation).

In contrast to a human neutral's subjective view of a dispute, which is limited by the human neutral's experience and capacity to understand various disputes, the system 110 utilizes the accumulated data as source of prediction.

In preferred embodiments, the analyzer 610 may assemble a plurality of datasets about one or more attributes of the matter. The analyzer 610 may collect information about the matter, using internet or other available resources.

The analyzer 610 may detect a significant impediment to an effective disposition if there are extremely high distrust and influence from an aggressive lawyer who advised one of the matter parties, from recorded communications of the matter parties in the request/inquiry/input server 470.

Attributes that are related to a lower likelihood of successful termination of a matter may include: distrust against an opponent; higher complexity of facts and long duration of a dispute; trouble in communicating with an opponent; and external factors that discourage dispute resolution.

The analyzer 610 may establish a prediction formula, incorporating evaluation of various attributes and dispute resolution progress of numerous matters that have been collected in the matter server 460, the web scraper 630, and the memory 620. The prediction formula may reflect a type of dispute resolution, analysis of the plurality of datasets, and compiled data saved at the matter server 460.

The analyzer 610 may amend the prediction formula by updating evaluation of various attributes and dispute resolution progresses of matters after receiving inputs from the case management 510, or from recorded communications in the request/inquiry/input server 470.

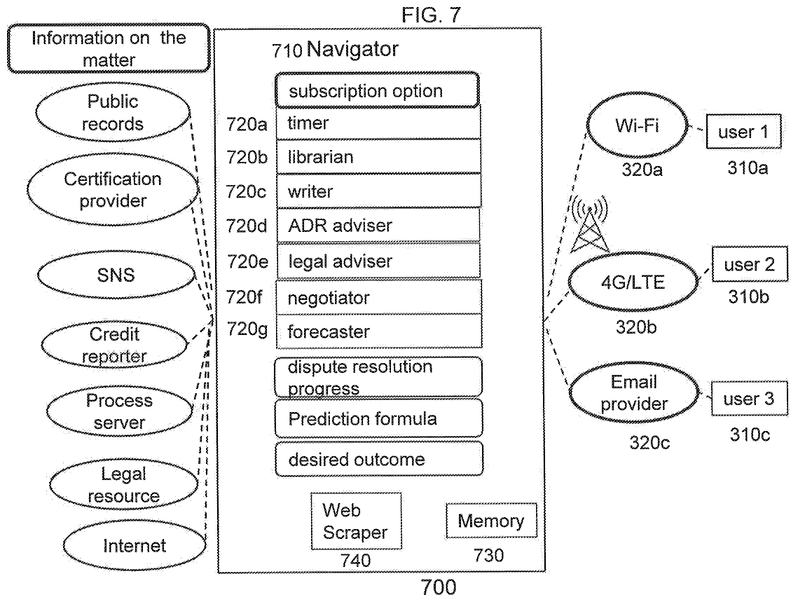

FIG. 7 illustrates an environment 700 in which the automated dispute resolution system may be implemented to advise the matter parties on the steps to resolve a dispute through use of the navigator 710. The navigator 710 may determine an action item for one or more of the matter parties based on the information on the matter, the dispute resolution progress, considering the prediction with the one or more attributes of the matter, any or all of which may be retrieved from the analyzer 610.

The navigator 710 may prompt the case manager to perform the action item or prompt the one or more of the matter parties to perform the action item. The matter parties and the case manager may be alarmed when action items are incomplete at their deadlines.

As depicted in FIG. 7, the navigator 710 may also facilitate a dispute disposition by a timer 720a, a librarian 720b, a writer 720c, an ADR adviser 720d, a legal adviser 720e, a negotiator 720f, a forecaster 720g.

The communicating user 1 310a may receive information about each of the aforementioned subscription options from the navigator 710, via I/O interface 150. The user 310a may decide to utilize a subscription (“subscribing party”), such as a timer.

When there is a specific question from a subscribing party, the navigator 710 may collect further information from internet by a web scraper 740, from the components of the matter that are stored at the memory 530 of the case management 510, from the matter server 460, and the request/inquiry/input server 470.

In preferred embodiments, the timer 720a alarms a subscribing party to perform an action item when the navigator 710 created the action item for the subscribing party. The timer 720a service is useful busy users and forgetful users.

The librarian 720b may receive a search request from a subscribing party and returns a search result. The librarian 702b may inform the subscribing party and reduce uncertainty and other barriers to effective dispute resolution. The librarian 720b may be useful for people with limited means and those who cannot gather on-point information and cannot engage an attorney.

The writer 720c may create both legal and non-legal documents that a subscribing party may need. The writer 720c may determine what content should be in a document and develop a persuasive argument if the subscribing party need to submit his or her side of a story.

The writer 720c may prepare a well-organized statement in a designated format such that a neutral may admit the statement and find facts correctly. The subscription may save the risk of losing a matter by presenting an argument in an effective manner.

The legal advisor 720e may be a service that provides essential information regarding settlement, mediation, or arbitration. A subscribing party is able to learn and understand, for instance, what options are available before a neutral's decision, what are downsides of going through mediation.

In some embodiments, the legal advisor 720e may be more individualized for a subscribing party. The legal advisor 720e may prepare a list of information and advice in accordance with the subscribing party's desired outcome and alleged facts.

The ADR advisor 720d may be configured to provide recommendations regarding settlement. In some embodiments, the ADR advisor 720d may create a plurality of action items that promote a probability of realizing the desired outcome of a subscribing party when a subscribing party subscribed for the settlement advisor

The ADR advisor 720d can summarize positions of a subscribing party and his or her opponent. The ADR advisor 702d may explain possible settlement scenarios and options for the subscribing party. The ADR advisor 720d can advise the subscribing party to take certain actions to preserve his or her optimal chance of realizing a desired outcome (for example, taking a collateral to secure future payments).

The negotiator 720f may automatically produce a subscribing party's response during negotiation. The negotiator 720f can provide reports on progress of negotiation to the subscribing party and receive the subscribing party's instructions.

The negotiator 720f may act within settlement condition given by a subscribing party. The subscribing party may set a monetary cap on any offer from the negotiator 720f.

In one example, the negotiator 720f may use available external resources to discover information conflicting an opponent's statement and argue for rejection of the opponent's assertion.

The forecaster 720g may predict and advance the possibility of realizing a desired outcome of a subscribing user. The forecaster 720g may display a probability of realizing the desired outcome of a subscribing party.

The navigator 710 may collect information on the matter from public records, from internet by a web scraper 740, from the components of the matter that are stored at the memory 530 of the case management 510, from the matter server 460, and the request/inquiry/input server 470. The information on the matter may be shared with the timer 720a, the writer 720c, the ADR advisor 720d, the legal advisor 720e, the negotiator 720f, and forecaster 702g.

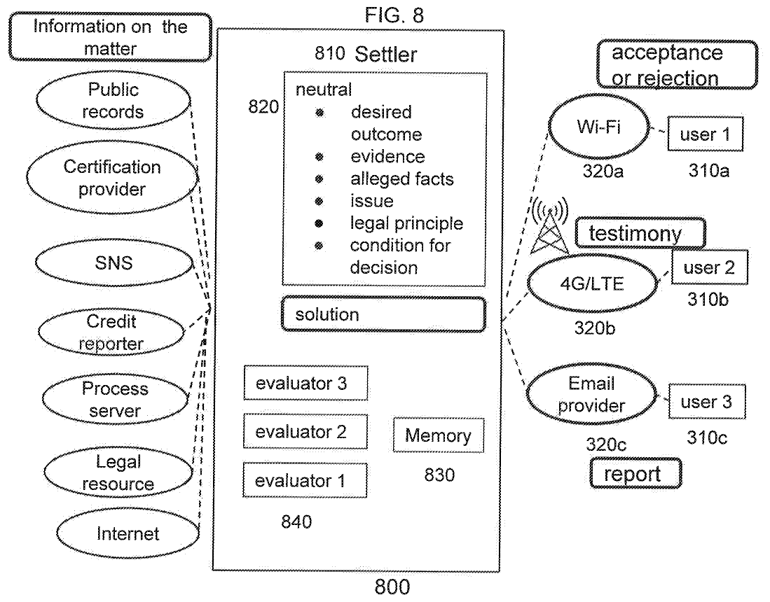

FIG. 8 illustrates an environment 800 in which the automated dispute resolution system may be implemented to process disputes to their conclusion at the settler 810.

There are types of dispute resolution in which a decision by a neutral is binding upon the matter parties and the matter parties may not reverse the decision unless there is an extraordinary circumstance such as a fraud on the neutral. There are types of dispute resolution in which a decision by a neutral is only advisory or informative. In arbitration, the settler module provides a binding solution to matter parties. On the contrary, the settler module provides a non-binding solution to matter parties in mediation.

The settler 810 may identify a solution based on the type of dispute resolution, the dispute resolution progress, and desires of the matter parties. The solution may be stored at the memory 830.

The settler 810 may then present the solution to the matter parties and record a date and time when the solution has been delivered at the memory 830.

The settler's dispute resolution may be performed wholly or partially by a neutral 820 and/or an evaluator 840. The evaluator 840 may be utilized to calculate a value of a property or authenticity of documents (e.g., a will).

The evaluator may collect information on the matter from public records and internet, from the components of the matter that are stored at the memory 530 of the case management 510, from the matter server 460, and the request/inquiry/input server 470. The information on the matter may be shared with the neutral 820.

A solution may be modifiable in certain circumstances, especially when the solution is interim in nature. A modifiable solution may be revised by the settler 810 when it is reasonable to do so.

The settler 810 may receive evidence from the matter parties and determine an action item for a neutral that is expected to advance dispute resolution progress when the type of dispute resolution is a decision by a neutral.

The settler 810 may, in certain embodiments, determine whether information needs to be collected from a witness or a relevant third-party to advance the dispute resolution progress based on the prediction and the dispute resolution progress.

The neutral 820 may determine whether the alleged facts are supported by evidence or determine a legal principle, may resolve the issue in accordance with the legal principle and the alleged facts when evidence supports the alleged facts.

The settler 810 may determine an action item for one or more of the matter parties based on the information on the matter, the dispute resolution progress, and the prediction, any or all of which may be retrieved from the analyzer 610.

The settler 810 may determine whether sharing a piece of the information on the matter with one or more of the matter parties advances the dispute resolution progress (by increasing trust, etc.) when the type of dispute resolution is not a decision by a neutral. The settler 810 may determine what type of communication method to be used and which of the matter parties to share the piece of the information on the matter in such situation.

The settler 810 of the disclosed system presents a solution to the matter parties when the matter is ready for disposition.

The settler may establish party-to-party secure communication when the party-to-party communication is expected to advance the dispute resolution progress.

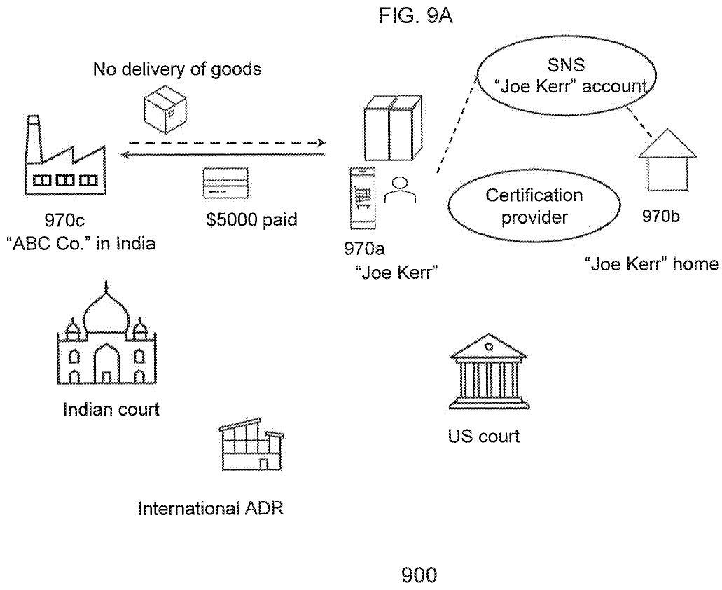

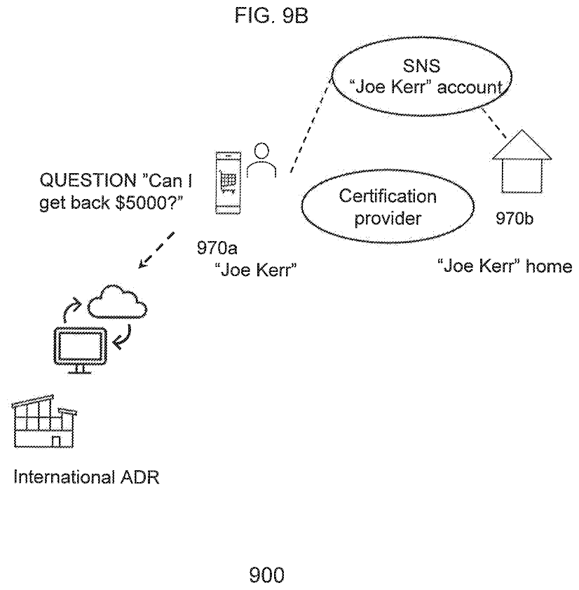

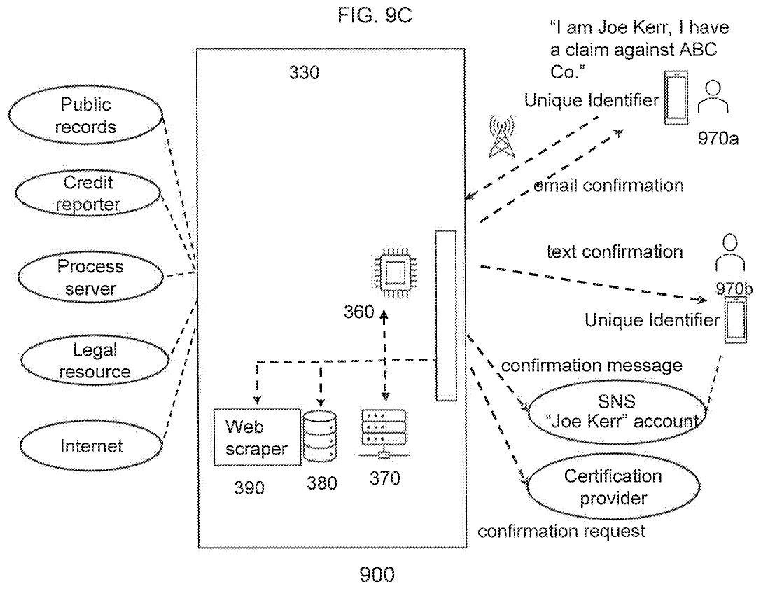

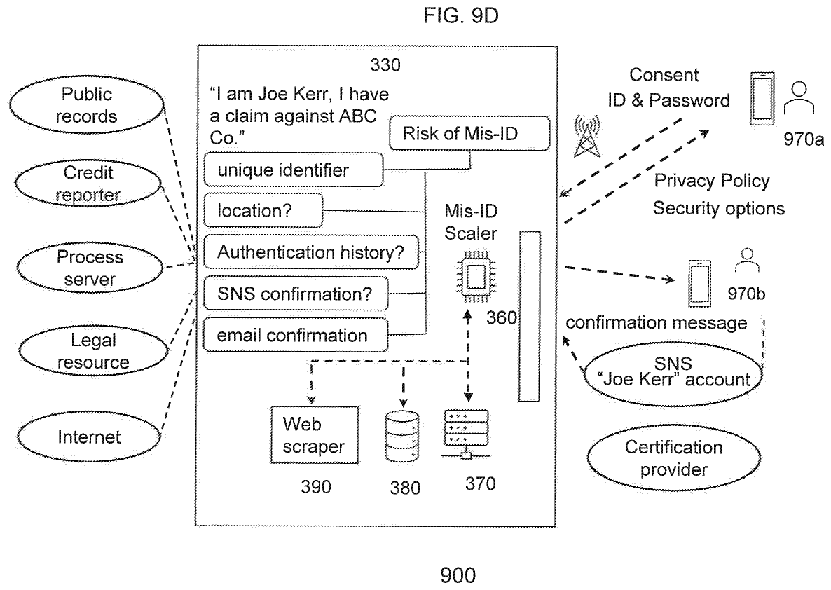

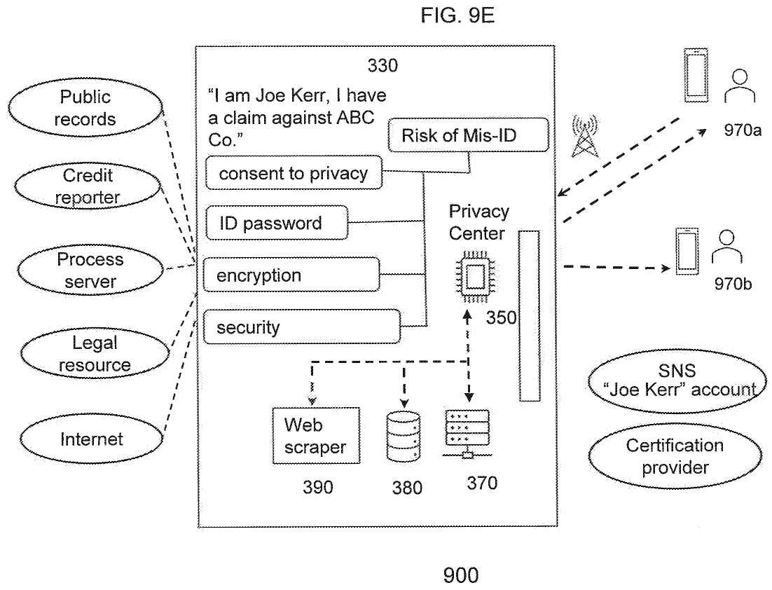

FIG. 9A to 9E illustrate an exemplary environment in which the automated dispute resolution system operates. A communicating party Joe Kerr 970a bought a stereo from an online seller, an Indian company ABC Co. 970c, and did not receive the stereo, and describe how ABC Co. 970c and Joe Kerr 970a may interact with and use the automated dispute resolution system 110.

Joe Kerr 970a paid $5000 for the stereo and would like to receive the stereo as promised or receive a refund. Joe Kerr 970a has an account under his name “Joe Kerr” at SNS (e.g., LinkedIn), but does not subscribe for a certification service of his electronic signature. His home computer 970b has been used to access the SNS account.

Joe Kerr 970a may not be able to initiate a legal action in Indian court without a help of an Indian lawyer. And Joe Kerr 970a does not know whether a US court can decide for him in a speedy manner and whether a judgment from a US court can be enforced against ABC Co. 970c in India. Therefore, Joe Kerr 970a may want to use an international ADR institution.

In preferred embodiments, the system of the international ADR institution may be accessible from a mobile phone of Joe Kerr 970a. Thus, Joe Kerr 970a may access a website and may send a message via the system's API or any I/O interface 150. In FIG. 9B, Joe Kerr 970a asks the system “Can I get back $5000?”

FIG. 9C illustrates how the system 110 may verify identity of Joe Kerr 970a via the verifier 330. For example, the verifier may receive identification information from Joe Kerr 970a, including the unique identifier of the mobile phone. If Joe Kerr 970a provides an email address as a part of identification information, the verifier 330 may confirm the email address by sending a confirmation email.

The verifier 330 may also use external information such as public records or internet websites and find a home phone number 970b or a second mobile phone number of Joe Kerr “Joe Kerr.” The verifier 330 may send a text confirmation to the second mobile phone number and request confirmation from Joe Kerr's SNS via his account.

The Mis-ID scaler 360 may use explicit authentication (confirmation of email address or SNS account confirmation), implicit authentication (location information), and authentication history to calculate a risk of misidentification of Joe Kerr 970a.

FIG. 9D illustrates how the system 110 may obtain Joe Kerr's consent to its privacy policy and create credentials for Joe Kerr 970a.

The privacy center 350 may provide the privacy policy and obtain consent from Joe Kerr 970a.

The log-in center 340 may provide security options to Joe Kerr 970a, and Joe Kerr 970a may choose his ID & password combination. Joe Kerr may also opt for a two step authentication or a two factor authentication.

The verifier 330 may save a statement of Joe Kerr 970a “I am Joe Kerr, I have a claim against ABC Co.” as well as the location of Joe Kerr, the authentication history of Joe Kerr, the SNS confirmation, and the email confirmation in the memory 380.

When the Mis-ID scaler 360 produces the risk of misidentification, the risk of misidentification may be combined with the saved statement, location, authentication history, SNS confirmation, email confirmation, to be saved at the ID server 370.

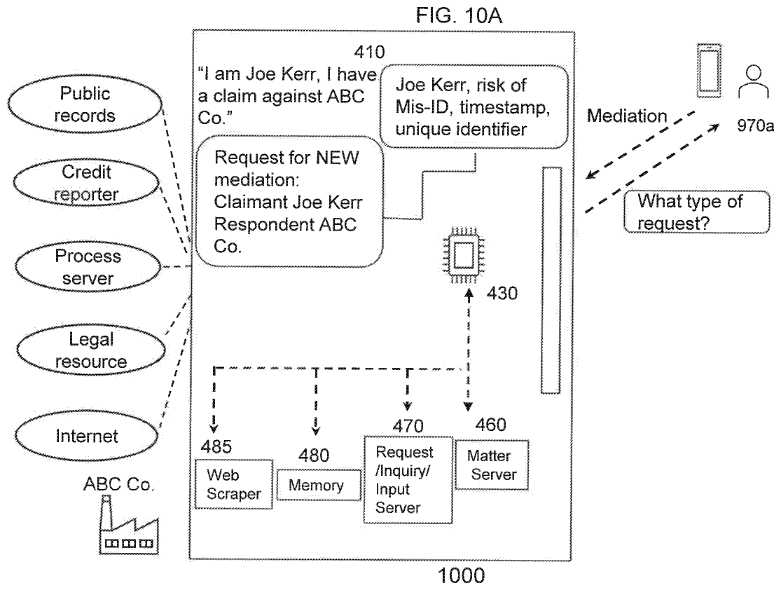

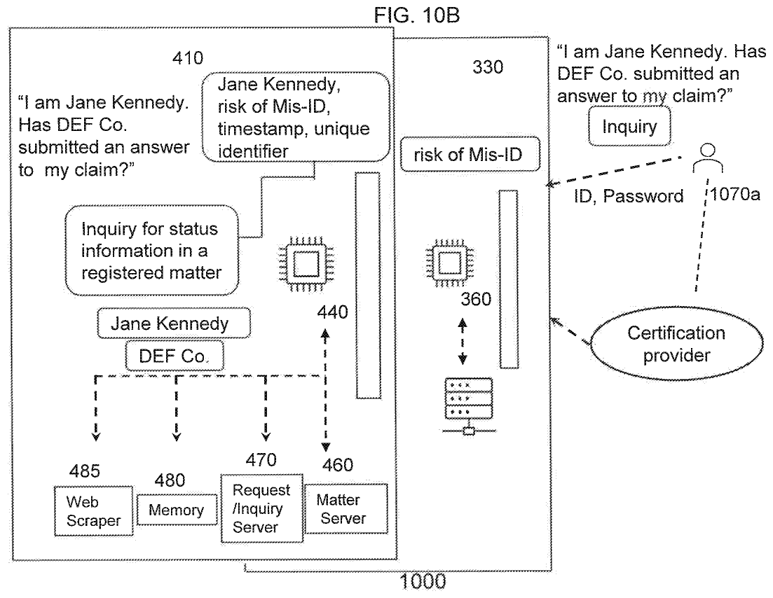

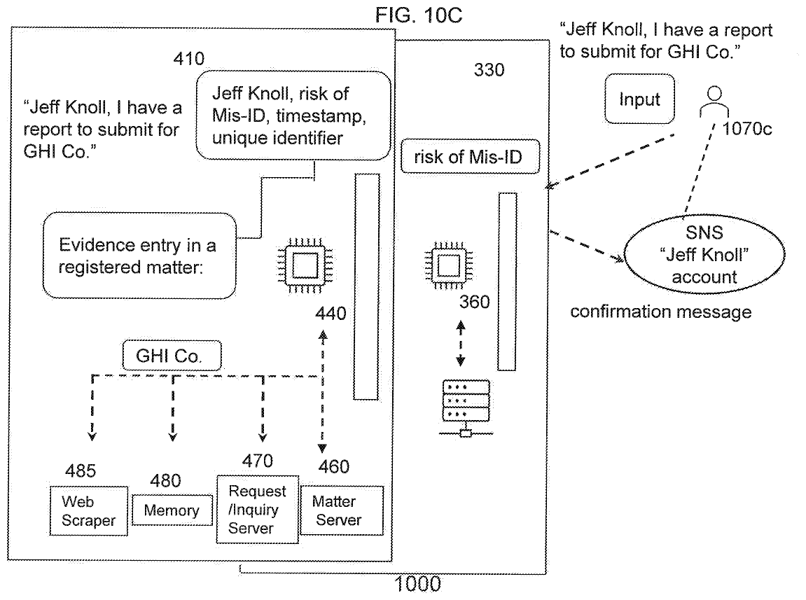

FIG. 10A to 10C are flow diagrams illustrating exemplary information processing by the record 410 of the system 110.

FIG. 10A illustrates recording of a communication made by Joe Kerr 970a, who wishes to initiate a mediation with ABC Co. 970c using the system 110.

In preferred embodiments, after receiving from the verifier 330, Joe Kerr's statement (“I am Joe Kerr, I have a claim against ABC Co.”) with the risk of misidentification, the request handler 430 may ask Joe Kerr what type of request Joe Kerr intends to make, among different types of dispute resolution.

The record 410 may, retrieve data on types of dispute resolution from the request/inquiry/input server 470 for the request handler 430. The record 410 may create an entry of a communication from Joe Kerr 970a into the memory 480 as below.
“I am Joe Kerr, I have a claim against ABC Co.”
“Joe Kerr” “5% risk of misidentification” “3:30 PM EST, May 2, 2022” “identifier SME 0123456”

Joe Kerr 970a will receive privacy policy and provide his response to an input request from the privacy center 440, and will set his credentials at the log-in center 450.

In preferred embodiments, when a new request for dispute resolution is received by the record 410, recorded communications about a dispute will be saved at the matter server 460, after the recorded communications are processed by the request/inquiry/input server 470.

The web scraper 485 may collect information about ABC Co. so that a respondent to Joe Kerr's matter is properly identified.

The matter between Joe Kerr against ABC Co. may be then relayed to the case management 510.

FIG. 10B illustrates exemplary operations of the system 110 and involved components when a claimant Jane Kennedy 1070a asks the system whether her opponent (usually called “respondent”) has answered to her claim in a pending matter. Jane 1070a wishes to know the status of her matter and provides her credentials, via her certification provider, to the I/O Interface 150. The verifier 330 may convey the determined risk of misidentification (2%) to the record 410. The inquiry handler 440 may clarify Jane's inquiry by eliciting more information about her matter. The matter checker 420 may retrieve information about her matter from the matter server 460.

The record 410 may create an entry of a communication from Jane 1070a into the memory 480 as below.
“I am Jane Kennedy. Has DEF Co. submitted an answer to my claim?”
“Jane Kennedy” “2% risk of misidentification” “12:40 PM EST, Mar. 26, 2022” “identifier IP address 0123456”

In preferred embodiments, when an inquiry about a pending matter is received by the record 410, and a recorded inquiry will be saved at the memory 480, after the recorded communication are processed by the request/inquiry/input server 470. Jane may receive a response from the record 410 after the inquiry handler 440 retrieves DEF Co.'s answer from data about her matter at the matter server 460. The inquiry handler 440 may make an entry about the provided response to Jane in the matter server 460.

FIG. 10C illustrates exemplary operations of the system 110 and involved components when an expert Jeff Knoll 1070b submits his report to the system in a pending matter.

When Jeff 1070b states that he has a report to submit in a matter involving GHI Co., the verifier 330 may send a confirmation message to his SNS account to verify his identity. In the alternative, Jeff 1070b may provide his credentials that the log-in center 340 can authenticate itself.

The verifier 330 may convey the determined risk of misidentification (8%) to the record 410. The input register 450 may clarify Jeff's input by eliciting more information about GHI Co.'s matter. The matter checker 420 may retrieve information about the matter from the matter server 460.

The record 410 may create an entry of a communication from Jeff 1070b into the memory 480 as below.
“Jeff Knoll, I have a report to submit for GHI Co.”
“Jeff Knoll” “8% risk of misidentification” “7:40 PM EST, Sep. 20, 2021” “identifier IP address 03456789”

In preferred embodiments, when an input about a pending matter is received by the record 410, and a recorded input will be saved at the memory 480, after the recorded communication are processed by the request/inquiry/input server 470. Jeff may receive a response from the record 410 after the input register 450 retrieves GHI Co.'s matter at the matter server 460. The input register 450 may make an entry about the report and the provided response to Jeff in the matter server 460.

FIG. 11A illustrates exemplary operations of the system 110 and involved components when a new matter requested by Joe Kerr 970a is entered into the case management 510.

The case management 510 may produce a notice to ABC Co. (the matter's respondent) about Joe Kerr's matter. The notice may be delivered to ABC Co. by Joe Kerr 970a, or by the record 410 when Joe Kerr 970a faces difficulty delivering the notice and requests the case management 510 to deliver the notice to ABC Co.

The case management 510 may obtain information about ABC Co. 970c from various resources, such as public records, a certification provider, a process server, internet, legal resources, and SNS, using a web scraper 385. The memory 530 may retain data about ABC Co 970c.

The verifier 330 may communicate with ABC Co. 970c after verifying identity through sending a confirmation message to ABC Co's SNS account, sending a confirmation request to a certification provider, checking public records.

The date notice has been issued may be entered into the matter server 460.

FIG. 11B illustrates exemplary operations of the system 110 and involved components when a response is received from ABC Co.

In some embodiments, ABC Co. 970c may submit its response to the record 410 via I/O 150.

The request handler 430 may process ABC Co's statement “We are ABC Co., can we talk to Joe?” as ABC's willingness to proceed with mediation.

The matter checker 420 may retrieve data about the matter and provide data to the request handler 430. Data may also be saved at the memory 480. ABC Co's statement may be recorded with the risk of misidentification, the timestamp, an IP address, etc. at the matter server 460.

FIG. 11C illustrates exemplary operations of the system 110 and involved components when ABC Co.'s response is entered into the record 410 and saved at the matter server 460.

When a respondent refuses to mediate a dispute, a claimant may not force the respondent to mediate the dispute. Mediation is voluntary and also not binding. If a respondent agrees to mediation, the case management 510 may advance dispute resolution.

In some embodiments, the case management 510 will schedule a mediation hearing of Joe Kerr 970a and ABC Co. 970c through the scheduler 540. The case management 510 may assign a case manager 520, and prompt Joe Kerr 970a and ABC Co. 970c to submit arguments to the record 410 via I/O 150.

The case manager 520 may talk with Joe Kerr 970a and ABC Co. 970c to collect information about their dispute.

Each module (the verifier 330, the record 410, the case management 510, the analyzer 610, the navigator 710, the settler 810) of the system 110 may include computing resources. In some implementations, computing resources may include any hardware and/or software used to process data. For example, computing resources may include hardware and/or software capable of executing algorithms, computer programs, and/or computer applications. In some implementations, exemplary modules may include application servers and/or databases with storage and retrieval capabilities (as shown in FIG. 1). Each module may be connected to any other module in a cloud computing environment. In some implementations, the modules may be connected over a computer network 508. Each module may be connected to one or more computing device over the computer network.

The processor 120 may include a resource allocator. The resource allocator may be connected to the modules and computing devices over networks. In some implementations, the resource allocator may facilitate the provision of computing resources by one or more modules to one or more computing devices. The resource allocator may receive a request for a computing resource from a particular module. The resource allocator may identify one or more modules capable of providing the computing resource requested by the module. The resource allocator may select a module to provide the computing resource. The resource allocator may facilitate a connection between the module and a particular computing device. In some implementations, the resource allocator may establish a connection between a particular module and a particular computing device.

The techniques provided by the embodiments herein may be implemented on an integrated circuit chip (not shown). The chip design may be created in a graphical computer programming language, and stored in a computer storage medium (such as a disk, tape, physical hard drive, or virtual hard drive such as in a storage access network).

The embodiments herein can take the form of an entirely hardware embodiment, an entirely software embodiment or an embodiment including both hardware and software elements. The embodiments that are implemented in software include but are not limited to, firmware, resident software, microcode, etc.

For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The system 110 may include one processor 120 coupled directly or indirectly to the memory 135 through a system bus. The memory 135 can include local memory employed during actual execution of the program code, bulk storage, and cache memories which provide temporary storage of at least some program code in order to reduce the number of times code must be retrieved from bulk storage during execution.

Input/output (I/O) interface 150 (including but not limited to keyboards, displays, pointing devices, etc.) can be coupled to the system 110 either directly or through intervening I/O controllers. Network adapters may also be coupled to the system 110 to enable the processor 120 to become coupled to other data processing systems or remote printers or storage devices through intervening private or public networks. Modems, cable modem and Ethernet cards are just a few of the currently available types of network adapters.

A representative hardware environment for practicing the embodiments herein may comprise at least one processor or central processing unit (CPU) 120. The CPUs 120 may be interconnected via system bus to various devices such as a random access memory (RAM), read-only memory (ROM) 135, and an input/output (I/O) interface 150. The I/O interface 150 may connect to peripheral devices, such as disk units and tape drives, or other program storage devices that are readable by the system. The system can read the inventive instructions on the program storage devices and follow these instructions to execute the methodology of the embodiments herein. The system 110 may further include a user interface adapter that connects a keyboard, mouse, speaker, microphone, and/or other user interface devices such as a touch screen device to the bus to gather user input.

As a computing device, the system 110 may include a high-speed interface connecting to the memory 135 and multiple high-speed expansion ports, and a low-speed interface connecting to a low-speed expansion port. Each element of the system 110 may be mounted on a common motherboard or in other manners as appropriate. The processor 120 can process instructions for execution within a computing device, including instructions stored in the memory 135 or on a storage device to display graphical information for a GUI on an external input/output device, such as a display coupled to the high-speed interface. In other implementations, multiple processors and/or multiple buses may be used, as appropriate, along with multiple memories and types of memory. Also, multiple computing devices may be connected, with each device providing portions of the necessary operations.

The storage device is capable of providing mass storage for the computing device. In some implementations, the storage device may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor), perform one or more methods, such as those described above. The instructions can also be stored by one or more storage devices such as computer- or machine-readable mediums.

The high-speed interface manages bandwidth-intensive operations for the computing device, while the low-speed interface manages lower bandwidth-intensive operations. Such allocation of functions is an example only. In some implementations, the high-speed interface is coupled to the memory 135, the display (e.g., through a graphics processor or accelerator), and to the high-speed expansion ports, which may accept various expansion cards. In one exemplary implementation, the low-speed interface is coupled to the storage device and the low-speed expansion port. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device may be implemented in a number of different forms. For example, it may be implemented as a standard server, or multiple times in a group of such servers. In addition, it may be implemented in a personal computer such as a laptop computer. It may also be implemented as part of a rack server system. Alternatively, components from the computing device may be combined with other components in a mobile device (not shown), such as a mobile computing device. Each of such devices may contain one or more of the computing device and the mobile computing device, and an entire system may be made up of multiple computing devices communicating with each other.

The processor can execute instructions within the mobile computing device, including instructions stored in the memory 614. The processor may be implemented as a chipset of chips that include separate and multiple analog and digital processors. The processor may provide, for example, for coordination of the other components of the mobile computing device, such as control of user interfaces, applications run by the mobile computing device, and wireless communication by the mobile computing device.

The processor 120 may communicate with a communicating user 170 through the I/O interface 150 and a display interface coupled to the display. The display may be, for example, a TFT (Thin-Film-Transistor Liquid Crystal Display) display or an OLED (Organic Light Emitting Diode) display, or other appropriate display technology. The display interface may comprise appropriate circuitry for driving the display to present graphical and other information to a communicating user 170. In addition, an external interface may provide communication with the processor 120, so as to enable near area communication of the mobile computing device with other devices. The external interface may provide, for example, for wired communication in some implementations, or for wireless communication in other implementations, and multiple interfaces may also be used.

The system 110 may also communicate audibly using an audio codec, which may receive spoken information from a communicating user 170 and convert it to usable digital information. The audio codec may likewise generate audible sound for a user, such as through a speaker. Such sound may include sound from voice telephone calls, may include recorded sound (e.g., voice messages, music files, etc.) and may also include sound generated by applications operating on the mobile computing device.

To provide for interaction with a communicating user 170, the systems and techniques described here can be implemented on a computer having a display device (e.g., a CRT (cathode ray tube) or LCD (liquid crystal display) monitor) for displaying information to the communicating user 170 and a keyboard and a pointing device (e.g., a mouse or a trackball) by which the communicating user 170 can provide input to the computer. Other kinds of devices can be used to provide for interaction with the communicating user 170 as well; for example, feedback provided to the communicating user 170 can be any form of sensory feedback (e.g., visual feedback, auditory feedback, or tactile feedback); and input from the communicating user 170 can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and a server are generally remote from each other and typically interact through a communication network. The relationship of a client and a server arises by virtue of computer programs running on the respective computers and having a client-server relationship to each other.

The foregoing description of the specific embodiments will illustrate the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

According to one or more embodiments, an automated dispute resolution system in data communication with a user device is provided. In preferred embodiments of the instant disclosure, the automated dispute resolution system allows verification of user identity and authentication of communications from matter parties using various resources. Therefore, users who don't know an exact address of their opponents may request dispute resolution without consulting a lawyer. The use of electronic communications for dispute resolution is finally at an experimental stage. User identification may be computerized, and more reliable and accurate when there are multiple modalities to verify identity of a communicating user. The disclosed system records a detected used identifier when a user communicates with the system and timestamps a communication. The recording of communication methods prevents the possibility of future disputes involving the user's communication and facilitates documentation of an arbitration agreement. The disclosed system efficiently solves privacy issues for users wherever they are located by displaying privacy policy and prompting consent from users. Data privacy protection is quintessential in dispute resolution, which is expected to offer private resolutions. A system for dispute resolution should respect privacy. The case management module may receive information about components of the matter, such as matter parties, alleged facts, a desire of a communicating user, determine a type of dispute resolution for the matter, assign a case manager, and select a track to efficiently manage the matter. The disclosed system may assist users by automatically creating action items that furthers a dispute resolution progress and prompting performance of the action items. A user may be encouraged to proceed with a claim, even without a legal counsel. The disclosed system may collect information on the matter, assemble a plurality of datasets to evaluate various attributes related to unsuccessful disposition of disputes previously entered, establish a prediction formula from compiled data including one or more attributes of disputes, and apply the prediction formula to establish a prediction specific to the matter. The attributes that lower the prediction of successful resolution of the matter are likely hinderances to effective and speedy dispute resolution. The prediction may direct the matter parties to work on problems that are causing stagnation of dispute resolution. The prediction may also identify errors (neglect by a case manager, typo, non-delivery of communications), unfeasibility of preparing a witness or an expert, a delay in proceedings, a disproportionate demand made by one or more of the matter parties, etc. The navigator may determine an action item for one or more of the matter parties based on information on the matter, the dispute resolution progress, and the prediction. The disclosed system may guide users with optional subscription services if so chosen. The navigator may offer an option to subscribe for various services. The options may include a timer; a librarian; a writer; a legal advisor; an ADR adviser; a negotiator; and a forecaster. The disclosed system may settle a matter by identifying a solution based on the type of dispute resolution (arbitration, mediation, etc.), the dispute resolution progress (whether the matter is mature enough to be disposed), and desires of the matter parties (what remedies the mater parties have requested). The settler module may determine a legal principle, receive evidence from matter parties, and determine whether the alleged facts are supported by evidence when the type of dispute resolution is a decision by a neutral. In certain embodiments, the settler module may establish party-to-party secure communication when the party-to-party communication is expected to advance dispute resolution progress.

According to one or more embodiments, a method for efficient and effective dispute resolution comprising: receiving identification information from a communicating user, scaling a risk of misidentification of the communicating user; recording a communication from the communicating user in the memory, together with a timestamp; receiving the communicating user's input to components of a matter when the communication desires initiation of dispute resolution, wherein the components of the matter comprise: matter parties; alleged facts; and a desire of the communicating user; collecting information on the matter; evaluating one or more dispute attributes; scaling a dispute resolution progress until the matter is terminated; establishing a prediction based on a type of dispute resolution and the one or more attributes; creating an action item for one or more of the matter parties according to the dispute resolution progress, considering the prediction together with the one or more attributes; identifying a solution based on the type of dispute resolution, the information on the matter, the dispute resolution progress, and desires of the matter parties; and presenting the solution to the matter parties.

What is claimed is:

1. An automated dispute resolution system in data communication with a user device comprising:
a memory; and
a processor,
the processor configured to:
receive identification information from a communicating user;
scale a risk of misidentification of the communicating user;
record a communication from the communicating user in the memory, together with a timestamp; and
receive the communicating user's input to components of a matter when the communication desires initiation of dispute resolution, wherein the components of the matter comprise: matter parties; alleged facts; and a desire of the communicating user.

2. The automated dispute resolution system of claim 1,
the processor further configured to:
scale dispute resolution progress of the matter until the matter is terminated.

3. The automated dispute resolution system of claim 1,
the processor further configured to:
collect information on the matter; and
evaluate one or more attributes about the matter.

4. The automated dispute resolution system of claim 3,
the processor further configured to:
establish a prediction based on a type of dispute resolution and the one or more attributes.

5. The automated dispute resolution system of claim 4,
the processor further configured to:
create an action item for one or more of the matter parties according to dispute resolution progress of the matter, considering the prediction together with the one or more attributes.

6. The automated dispute resolution system of claim 4,
the processor further configured to:
identify a solution based on the type of dispute resolution, the information on the matter, dispute resolution progress of the matter, and desires of the matter parties; and
present the solution to the matter parties.

7. A method, comprising:
receiving identification information from a communicating user;
scaling a risk of misidentification of the communicating user;
recording a communication from the communicating user in a memory, together with a timestamp;
receiving the communicating user's input to components of a matter when the communication desires initiation of dispute resolution, wherein the components of the matter comprise: matter parties; alleged facts; and a desire of the communicating user.

8. The method of claim 7, further comprising:
scaling dispute resolution progress of the matter until the matter is terminated.

9. The method of claim 7, further comprising:
collecting information on the matter; and
evaluating one or more attributes about the matter.

10. The method of claim 9, further comprising:
establishing a prediction based on a type of dispute resolution and the one or more attributes.

11. The method of claim 10, further comprising:
creating an action item for one or more of the matter parties according to dispute resolution progress of the matter, considering the prediction together with the one or more attributes.

12. The method of claim 10, further comprising:
identifying a solution based on the type of dispute resolution, the information on the matter, dispute resolution progress of the matter, and desires of the matter parties; and
presenting the solution to the matter parties.
